(19) United States
(12) Patent Application Publication
(10) Pub. No.: US 2026/0117439 A1
(43) Pub. Date: Apr. 30, 2026

(54) Segmented and Rigid Patterned Forming Wire

(71) Applicant: Kimberly-Clark Worldwide, Inc., Neenah, WI (US)

(72) Inventor: Walter George Bauer, Neenah, WI (US)

(21) Appl. No.: 19/117,804

(22) PCT Filed: Oct. 24, 2022
(86) PCT No.: PCT/US2022/047558

§ 371 Date: Apr. 2, 2025

(51) Int. Cl. D04H 1/54; B33Y 80/00; D21F 7/08

(52) U.S. Cl. CPC D04H 1/54; B33Y 80/00; D21F 7/08; D10B 2509/026

(57) ABSTRACT

The present disclosure is directed to a forming wire having a pattern printed thereon. The printed pattern is formed from a rigid plastic, exhibits a pattern height of greater than 0.8 mm, and contains microscale gaps spaced apart in the machine direction that are not visible in a flat orientation. Due at least in part to the microscale gaps, as well as their manner of manufacturing, the forming wire of the present disclosure is capable of extending around idler rolls having a diameter as small as 7.5 mm.

### BACKGROUND

Fibrous nonwoven web materials are in wide use in a number of applications including, but not limited to, absorbent structures and wiping products, many of which are disposable. In particular, such materials are commonly used in personal care absorbent articles such as diapers, diaper pants, training pants, feminine hygiene products, adult incontinence products, bandages, and wiping products such as baby and adult wet wipes. They are also commonly used in cleaning products such as wet and dry disposable wipes which may be treated with cleaning and other compounds which are designed to be used by hand or in conjunction with cleaning devices such as mops. Yet a further application is with beauty aids such as cleansing and make-up removal pads and wipes.

In many of these applications, three-dimensionality and increased surface area are desirable attributes, and can be imparted via a variety of processes that texture or emboss the surface of the nonwoven web. Textures or decorative lines on nonwoven products may be achieved using patterned forming wires. However, as thicker, and more structured nonwoven products have become desirable, providing patterned forming wires capable of providing adequate surface texture has proven challenging.

Namely, it has recently been found that forming wires having larger pattern or element heights improve the surface texture of these thick and structured nonwoven products. However, in order to maintain movement of the nonwoven product in the machine direction, forming wires must be able to bend around rolls, such as idler rolls. Thus, it has not been possible to provide element or pattern heights of greater than 0.8 mm with materials having a high hardness and low flexibility, as the circular motion around existing rolls causes the patterns or structures on patterned forming wires having a large pattern or element height to deform or break, causing defects in the formed pattern. In addition, it has not proved possible to replace the rolls with those of a large enough diameter to prevent deformation or breakage of the forming wire, as diameters of more than four times those currently used would be necessary.

As such, it would be a benefit to provide a forming wire with a pattern height of greater than 0.8 mm that is compatible with existing idler rolls. It would further be a benefit to provide a forming wire with a pattern height of greater than 0.8 mm that is compatible with existing idler rolls where the pattern is formed from a rigid material. Yet another benefit would be to provide a forming wire with a pattern height of greater than 0.8 mm that utilizes existing printing materials to provide the patterned wire.

### SUMMARY

The present disclosure is generally directed to a forming wire that includes a substrate having a top surface, a bottom surface opposite to the top surface, an x-y plane, and a thickness extending from the bottom surface to the top surface in a z-direction perpendicular to the x-y plane, where the substrate includes a plurality of filaments and voids between the filaments. The substrate also includes a plurality of discrete sections that include at least a first section and a second section, where each section contains a continuous pattern disposed on the substrate. The continuous pattern exhibits a pattern height of greater than 0.8 mm, and has a microscale gap disposed between each discrete section of the plurality of discrete sections.

In one aspect, each discrete section has a section length of about 2 cm or less. Additionally or alternatively, in an aspect, the continuous pattern has a pattern height of greater than about 2 mm. Moreover, in one aspect, at least about 10% of the top surface of the substrate within a respective discrete section has the continuous pattern disposed thereon. In yet a further aspect, at least about 30% of adjacent pattern elements within a respective section share at least one connection point. Furthermore, in one aspect, the microscale gap disposed between each discrete patterned section has a gap width in a flat orientation of 500 micrometers or less.

In yet another aspect, the continuous pattern includes circles, ovals, triangles, crosses, squares, rectangles, diamond shapes, hexagons, other polygons, lines, swirls, stars, characters, emblems, or combinations thereof. Additionally or alternatively, in an aspect, the continuous pattern in each discrete section includes the same shape or combination of shapes. In yet another aspect, the continuous pattern in adjacent discrete sections includes a different shape or combination of shapes.

In a further aspect, the continuous pattern is formed from a polymeric material, optionally, in one aspect, wherein the polymeric material is a thermoplastic, an epoxy, or combination thereof. In an aspect, the plurality of filaments are formed from a thermoplastic resin, a silicone rubber, or a non-silicone vulcanized rubber. Moreover, in one aspect, the continuous pattern includes a first polymeric layer directly adjacent to the top surface of the substrate, wherein the first polymeric layer encircles and/or is fused to one or more substrate filaments. In a further aspect, a melting point of the polymeric material differs from a melting point of the substrate by about 20% or less.

In one aspect, the substrate is polyethylene terephthalate. Additionally or alternatively, the polymeric material is a glycol modified polyethylene terephthalate. Moreover, in an aspect, each microscale gap includes a gap region extending between adjacent discrete sections, where at least one gap region is generally free of the polymeric material. In one aspect, each respective gap region overlies a portion of the substrate, where the portion of the substrate within the gap region is generally free of the polymeric material. In a further aspect, the polymeric material is disposed on the substrate via additive manufacturing, preferably wherein the polymeric material is disposed on the substrate via a fused deposition modeling (FDM) process.

The present disclosure is also generally directed to a method of manufacturing a forming wire according to any one or more of the above aspects. The method includes: forming the continuous pattern on the substrate by dispensing onto the top surface of the substrate a first polymeric material layer from an extrusion head transported in the x and/or y plane over the top surface of the substrate, where at least a portion of the voids are filled with the polymeric material, and dispensing one or more additional layers of the polymeric material onto the first polymeric material layer until the pattern height is reached.

Furthermore, the present disclosure is also generally directed to a method of forming a nonwoven web that includes forming a plurality of fibers, disposing the plurality of fibers on the forming wire of any one or more of the above aspects, and drying the plurality of fibers.

Other features and aspects of the present invention are set forth in greater detail below.

### BRIEF DESCRIPTION OF THE DRAWINGS

FIG. 1 is a fragmentary top plane view of a substrate of the present disclosure;

FIG. 2 is a cross-sectional view of a substrate of the present disclosure;

FIG. 3 is a cross-sectional view of a substrate of the present disclosure with a polymeric material layer thereon;

FIG. 4 is a cross-sectional view of a substrate of the present disclosure with a polymeric material layer thereon and an additional layer contacting a polymeric material;

FIG. 5A is fragmentary top plane view of a forming wire according to the present disclosure in a flat orientation;

FIG. 5B is a side view of a forming wire according to the present disclosure in a flexed orientation;

FIG. 6A is a side plan view of a forming wire according to the present disclosure flexed around a 7.5 mm diameter roll;

FIG. 6B is a view of a comparative sample according to the Example; and

FIG. 6C is a view of a comparative sample according to the Example.

### DEFINITIONS

As used herein, the terms “about,” “approximately,” or “generally,” when used to modify a value, indicates that the value can be raised or lowered by 10%, such as, such as 7.5%, 5%, such as 4%, such as 3%, such as 2%, such as 1%, and remain within the disclosed aspect. Moreover, the term “substantially free of” when used to describe the amount of substance in a material is not to be limited to entirely or completely free of and may correspond to a lack of any appreciable or detectable amount of the recited substance in the material. Thus, e.g., a material is “substantially free of” a substance when the amount of the substance in the material is less than the precision of an industry-accepted instrument or test for measuring the amount of the substance in the material. In certain example aspects, a material may be “substantially free of” a substance when the amount of the substance in the material is less than 10%, less than 9%, less than 8%, less than 7%, less than 6%, less than 5%, less than 4%, less than 3%, less than 2%, less than 1%, less than 0.5%, or less than 0.1% by weight of the material.

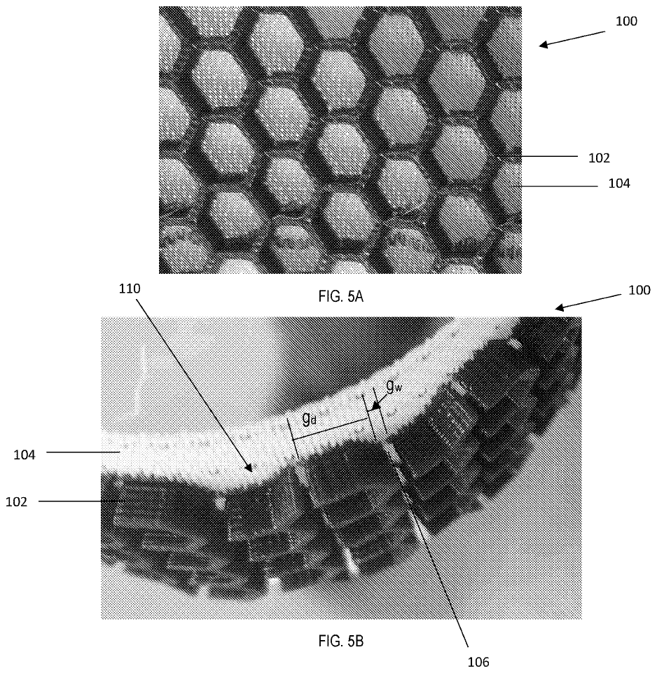

As used herein the term “Continuous” when referring to an element disposed on the surface of a tissue product, such as a line element, a design element or a pattern, means that the element extends throughout one dimension of the tissue product surface. A non-limiting example of a continuous pattern is illustrated in FIG. 5A where at least two or more adjacent pattern elements (e.g. individual hexagon shapes/design elements) within a respective section share at least one connection point. In addition, it should be understood that, in some aspects, an entire pattern may “appear” continuous in a flat orientation as will be discussed in greater detail below, as gaps extending in one or more dimensions may be smaller than visible to the human eye.

As used herein the term “Discrete” when referring to an element disposed on the surface of a tissue product, such as a line element, a design element or a pattern, means that the element is visually unconnected from other elements, does not share at least one connection point with one or more adjacent elements, and/or does not extend continuously in any dimension of the tissue product surface.

As used herein, the term “fabric” refers to cloth or paper products comprising a plurality of filaments and voids between the filaments. The fabric may be a woven or non-woven material, and may include papermaking/nonwoven forming fabric or products made from tissue webs (e.g., bath tissues, facial tissues, paper towels, wipes, (e.g., industrial, foodservice, or personal care wipes), napkins, medical pads, and the like). The fabric may be made from a variety of processes including, but not limited to, airlaid processes, wet-laid processes such as with cellulosic-based tissues or towels, hydroentangling processes, staple fiber carding and bonding, solution spinning, or an uncreped through air dried (UCTAD) process. The fabric may be made of a variety of materials, including natural fibers, synthetic fibers, or combinations thereof. As will be discussed in greater detail below, the terms “forming wire” and “forming fabric” may be used interchangeably herein.

As used herein “pattern” or “decorative pattern” refers to any non-random repeating design, figure, or motif. It is not necessary that the elements of the pattern form recognizable shapes, and a repeating design of the elements is considered to constitute a decorative pattern.

As used herein the term “aperture” refers to an opening disposed on one surface of a three-dimensional element as disclosed herein.

As used herein, the term “solid free form fabrication” (SFF) generally refers to the three-dimensional printing of material using any one of the well-known layer manufacturing processes, such as stereo lithography, selective laser sintering, inkjet printing, laminated object manufacturing, fused deposition modeling, laser-assisted welding or cladding, and shape deposition modeling. SFF typically involves representing a 3D object with a computer-aided design (CAD) geometry file, converting the design file into a machine control command, and using the command to drive and control a part-building tool for building parts essentially point-by-point or layer-by-layer.

As used herein, the term “additive manufacturing” refers to manufacturing techniques that form a three-dimensional object or element by adding layer-upon-layer of material. Additive manufacturing processes include solid free form fabrication and fused deposition modeling processes.

As used herein, the term “3D printed” generally refers to a fused deposition modeling process (hereinafter abbreviated to FDM) as described in U.S. Pat. No. 5,121,329, the contents of which are hereby incorporated by reference in a manner consistent with the present disclosure, and generally employs a heated nozzle to melt and extrude out a material. The build material is supplied into the nozzle in the form of a rod or filament.

The term “printing head” or “extrusion head”, used interchangeably herein, mean the entire device for the conveying, melting and application of a filament in an extrusion-based 3D printing process.

As used herein, the term “woven” generally refers to a structure formed from a plurality of interconnected filaments. Woven refers to structures comprising a plurality of filaments that have been interconnected by weaving two or more filaments together, such as by interlacing in a repeating pattern, as well as structures made of a multiplicity of helical coils or links of filaments such as wire-link belts disclosed, for example, in U.S. Pat. No. 5,334,440.

As used herein the term “nonwoven web” generally refers to a web having a structure of individual fibers or threads which are interlaid, but not in an identifiable manner as in a knitted fabric. Examples of suitable nonwoven fabrics or webs include, but are not limited to, meltblown webs, spunbond webs, bonded carded webs, airlaid webs, coform webs, hydraulically entangled webs, and so forth.

### DETAILED DESCRIPTION

It is to be understood by one of ordinary skill in the art that the present discussion is a description of exemplary aspects only, and is not intended as limiting the broader aspects of the present disclosure.

Generally speaking, the present disclosure is directed to a fabric having a continuous pattern disposed thereon, suitable for use as a forming wire during woven and nonwoven fabric formation. Namely, the present disclosure has surprisingly found that by forming microscale gaps at specific intervals in the pattern (e.g. microscale gaps between adjacent portions of the pattern), extending in the cross-machine direction (CD) and spaced apart in the machine direction (MD), the pattern will exhibit as continuous in a flat orientation, at an element or pattern height of greater than 0.8 mm, while allowing the pattern to bend around even very small diameter roller sections (flexed orientation) without deformation or breakage. Thus, the fabric having a continuous pattern disposed thereon of the present disclosure is unexpectedly capable of exhibiting an increased pattern height, while being compatible with small roller diameters.

Namely the present disclosure has surprisingly found that by creating microscale gaps extending in the cross-machine direction, continuous patterns having a pattern or element height of about 1 mm or greater can be formed while maintaining compatibility with standard sized idler rolls, such as about 1.2 mm or greater, such as about 1.4 mm or greater, such as about 1.6 mm or greater, such as about 1.8 mm or greater, such as about 2 mm or greater, such as about 2.2 mm or greater, such as about 2.4 mm or greater, such as about 2.6 mm or greater, such as about 2.8 mm or greater, such as about 3 mm or greater, such as about 3.2 mm or greater, such as about 3.4 mm or greater, such as about 3.6 mm or greater, such as about 3.8 mm or greater, such as even about 4 mm or greater, up to about 6 mm or less, such as about 5.5 mm or less, such as about 5 mm or less, such as about 4.5 mm or less, or any ranges or values therebetween. As may be understood by one having skill in the art, the pattern height refers to the z direction height of the pattern or element, determined as the distance between the surface of the substrate fabric and the top surface of the pattern, which will be discussed in greater detail in regards to the figures below.

As will be discussed in greater detail below, when in the flat orientation, the pattern appears continuous, where the microscale gaps may be virtually invisible to the human eye, such as a gap width (between adjacent sections of the patter) of about 1000 micrometers or less, such as about 500 micrometers or less, such as about 400 micrometers or less, such as about 300 micrometers or less, such as about 275 micrometers or less, such as about 250 micrometers or less, such as about 230 micrometers or less, such as about 25 micrometers or more, such as about 40 micrometers or more, or any ranges or values therebetween. However, in the flexed orientation, the microscale gaps can have a gap width of greater than about 250 micrometers, such as greater than about 500 micrometers, such about 750 micrometers or more, such about 1 millimeter or more, or any ranges or values therebetween. Namely, as will be discussed in greater detail below, the microscale gaps may be formed as absence of material disposed on the substrate during formation of the pattern, instead of a cut or other method of removing applied pattern material. Thus, in one aspect, the pattern is disposed on the substrate as a plurality of discrete sections spaced apart in the machine direction, while being continuous in the cross-machine direction. Without wishing to be bound by theory, it is believed that by forming the pattern as spaced apart and discrete sections with little to no pattern material being disposed on the substrate in the gap, excellent flexibility can be achieved without providing large gaps that would render the pattern non-continuous when in the flat orientation.

Nonetheless, as discussed above, the present disclosure has surprisingly found that the patterned forming wire according to the present disclosure can be utilized with standard sized idler rolls (such as those having diameters from about 30.5 cm to as small as about 7.5 cm) when the gaps are spaced apart (e.g. the respective section length) at a distance of less than about 2 cm, such as about 1.8 cm or less, such as about 1.6 cm or less, such as about 1.4 cm or less, such as about 1.2 cm or less, such as about 1 cm or less, such as about 0.5 cm or more, such as about 0.75 cm or more, or any ranges or values therebetween. Namely, the present disclosure has found that at a gap-to-gap distance (or respective section length) of less than 2 cm allows even patterns with pattern heights of about 4 cm (or even more) to flex around even a 7.5 cm diameter idler roll without cupping or causing damage or distortion to the pattern.

Furthermore, it should be understood that the patterns discussed herein are continuous within respective sections, meaning that at least two or more adjacent pattern elements within a respective section share at least one connection point. Namely, unlike embossing rolls or other textured rolls utilized for bonding or further surface structure which employ separate, discrete, and spaced apart elements, the forming wire patters discussed herein are interconnected, which brings rise to the need for improvements in flexibility. Thus, in one aspect, at least about 10% of the substrate surface within a respective section has a pattern disposed thereon, such as about 12.5% or more, such as about 15% or more, such as about 17.5% or more, such as about 20% or more, such as about 30% or more, such as about 40% or more, up to about 75% or less, such as about 70% or less, such as about 60% or less, such as about 50% or less, such as about 40% or less, such as about 30% or less, or any ranges or values therebetween. Furthermore, in an aspect, at least about 10% of adjacent pattern elements within a respective section share at least one connection point, such as about 20% or more, such as about 30% or more, such as about 40% or more, such as about 50% or more, such as about 60% or more, such as about 70% or more, such as about 80% or more, such as about 90% or more, such as substantially all of adjacent pattern elements within a respective section share at least one connection point. For instance, as will be discussed in greater detail below, in one aspect, respective elements within a respective section may share an entire side (such as when the pattern includes adjacent repeating elements of the same shape and design). However, it should be understood that the pattern may be continuous even when non-similar shapes are adjacent to one another within a respective section (e.g. a hexagon connected to a swirl or a letter).

It should be understood that any number of shapes and combination of shapes can be used depending on the end use application. Examples possible shapes for forming the forming wire pattern include, but are not limited to, circles, ovals, triangles, crosses, squares, rectangles, diamond shapes, hexagons, other polygons, lines, swirls, stars, characters, emblems, or the like, as well as combinations thereof. However, it should be understood that any shape may be utilized as long as it may be formed according to the height and continuity discussed herein. Furthermore, it should be understood that, in one aspect, the pattern in each discrete section may contain the same shape or combination of shapes, or alternatively, the pattern in adjacent sections can contain a different shape or combination of shapes from one another.

Nonetheless, in one aspect, the pattern can be formed on the substrate via additive manufacturing, and in particular, SFF, such as a fused deposition modeling (FDM) process. For instance, in one aspect, additive manufacturing can be utilized to fabricate three-dimensional (3D) elements on the substrate to form the pattern.

In one aspect, the use of additive manufacturing, such as FDM, in the production of patterned substrates having 3D elements or decorative patterns thereon, can include a polymeric on the substrate prior to formation of additional layers of the pattern. In some aspects, the polymeric can provides a platform for the addition of subsequent layers without damaging or otherwise compromising the strength of the substrate, and thus allows for more rapid printing of subsequent layer(s). In some aspects, the polymeric can also improve the adherence of FDM 3D elements to the surface of a fabric substrate by providing a surface for adherence of subsequent layers. However, as will be discussed in greater detail below, in some aspects, a polymeric is not necessary based upon the careful selection of substrate and pattern materials.

Regardless of whether a polymeric is formed, an initial layer of a polymer material is utilized to form a first layer of the pattern by dispensing onto a surface of the substrate a flowable polymer material from an extrusion head transported over a top surface of the substrate. The flowable polymer material is of a sufficiently low viscosity to allow the flowable polymer material to flow into void spaces present in the substrate. More specifically, upon contact with the substrate, the flowable polymer material flows in and around the filaments that form the substrate and into the voids, where the flowable polymer material and extrusion head partially melt and/or soften the substrate itself. Thus, as the flowable polymer material and substrate cool, the flowable polymer material and substrate solidify together, allowing the flowable polymer material to take the shape of the voids and encircle the filaments in addition to fuse the first layer of flowable polymer material and the substrate together, to mechanically secure the first flowable polymer layer to the substrate. The additional flowable polymer layers that form the pattern may then be printed onto the substrate and/or polymeric.

While substrates and polymer materials suitable for formation of FDM patterns are known in the art, the present disclosure has surprisingly found that when a substrate material and a flowable polymer material are selected such that the melting point of the flowable polymer material differs from the melting point of the substrate by about 20% or less, such as about 17.5% or less, such as about 15% or less, such as about 12.5% or less, such as about 10% or less, such as about 7.5% or less, such as about 5% or less, such as about 2.5% or less, or any ranges or values therebetween.

Furthermore, in an aspect, the melting point of the flowable polymer material, the melting point of the substrate, or both, is about 350° C. or less, such as about 325° C. or less, such as about 300° C. or less, such as about 275° C. or less, such as about 250° C. or less, such as about 225° C. or less, such as ab out 150° C. or more, or any ranges or values therebetween. Namely, when the melting point of the flowable polymer material, the melting point of the substrate, or both are selected according to the above, the extrusion head can adequately soften the flowable polymer material, the substrate, or both, providing a strong adhesion between the flowable polymer material and the substrate.

Nonetheless, in one aspect, the substrate may be formed from any suitable material that includes a plurality of filaments and voids between the filaments. The substrate may be, for example, a woven or non-woven material. The substrate may be made from a variety of processes including, but not limited to, airlaid processes, wet-laid processes such as with cellulosic-based tissues or towels, hydroentangling processes, staple fiber carding and bonding, and solution spinning. In one aspect, the substrate is produced using an uncreped through air dried (UCTAD) process. Examples of such processes are known in the art, and described in, for example, U.S. Pat. Nos. 6,736,935; 6,887,348; and 6,953,516, which are herein incorporated by reference.

The substrate may be a single layer or contain multi-layer. Examples of suitable substrates are described in, for example, WO 2019/028052 and US 2018/0209096, which are herein incorporated by reference to the extent they are consistent with the present disclosure.

The filaments (also referred to herein as “fibers”) forming the substrate may be made from a variety of materials. For instance, the filaments can include a thermoplastic resin, a silicone rubber, or a non-silicone vulcanized rubber made from at least a majority by weight of fluoroelastomer having good heat and chemical resistance. Suitable thermoplastic resins which can be used include, but are not limited to, polyvinyl fluoride, polyvinylidene fluoride, polyvinyl chloride, polyethylene, polypropylene, polyethers, styrene-butadiene copolymers, polybutylenes, polyethylene (“PE”), polypropylene (“PP”), polyphenylene sulfide (“PPS”), polyimides, polyamides, polysulfones, polysulfides, cellulosic resins, polyarylate acrylics, polyarylsulfones, polyurethanes, epoxies, poly(amide-imides), copolyesters, polyethersulfones, polyetherimides, polyarylethers, and the like, as well as combinations and copolymers thereof. In other instances the substrate may comprise a silicone rubber. In still other instances the substrate may comprise a fluoroelastomer layer bonded to a silicone rubber layer. In one aspect, the substrate comprises polyphenylene sulfide. Nonetheless, in one aspect, the substrate is formed from a polyester, such as, in an aspect, polyethylene terephthalate (PET).

Regardless of the substrate material selected, the substrate includes voids between the filaments. To assist the flowable polymer material of the first layer in filling the voids, in certain aspects, it can be desirable for the voids in the substrate to have a diameter of at least 100 um. In one aspect, the distance between the voids is about that of the extrusion width, or smaller.

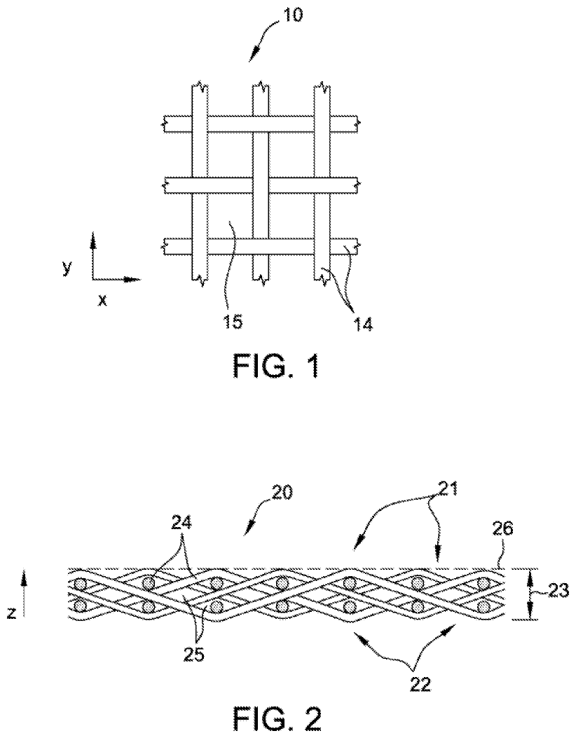

For instance, with reference to FIG. 1, depicted therein is a fragmentary top plane view of an exemplary substrate 10 (also referred to herein as a forming wire or fabric substrate). Substrate 10 is in an x-y plane, and includes a plurality of filaments 14 and voids 15 between the filaments. In aspects where the substrate is forming wire, the substrate 10 may have two principal dimensions —-a machine direction (“MD”), which is the direction within the plane of the belt 10 parallel to the principal direction of travel of the fabric during manufacture and a cross-machine direction (“CD”), which is generally orthogonal to the machine direction. The substrate 10 is generally permeable to liquids and air. The substrate may be any fabric material comprising void spaces internal to or between the filaments forming the substrate. For instance, the substrate may be a woven or non-woven fabric. In one particularly preferred aspect the substrate is a woven fabric.

With reference to FIG. 2, depicted therein is a cross-sectional view of an exemplary substrate 20. Substrate 20 is in an x-y plane and has a top surface 21, a bottom surface opposite to the top surface 22, and a thickness 23 extending from the bottom surface to the top surface in a z-direction perpendicular to the x-y plane. Substrate 20 comprises a plurality of filaments 24 and voids 25 between the filaments. In one aspect, the substrate may be substantially planar, or may have a three-dimensional surface defined by ridges. As depicted in FIG. 2, in one aspect, the top surface 21 of substrate 20 has an uneven topography, with certain points of the filaments being higher than other points of the filaments. In one aspect, the substrate 20 may be constructed so that the highest points of the filaments 24 are substantially coplanar and form a top 26 of the substrate.

Although the substrates of the present disclosure are typically planar, the topography of the surfaces of the substrates may vary. This is illustrated, for example, in FIG. 2, which illustrates an exemplary substrate wherein the height to which filaments in the substrate extend in the z direction varies. In certain instances, it may be desirable to determine the highest point to which filaments in the substrate extend in the z direction (e.g., the highest point of the top surface), in order to ensure the extruder head is set at a sufficient height to produce a polymeric material that extends above the top surface of the substrate. This point (i.e., the highest point of the top surface) is referred to herein as the “top” of the substrate.

Regardless of the substrate selected, the polymer material used to form the first pattern layer, additional pattern layers, or the entirety of the pattern (also referred to herein as “polymeric pattern material” or “polymeric material”) can be any material that may be used in additive manufacturing processes, such as FDM. In particular, the polymeric material may be any material that can melt to a flowable state, and re-solidify in the voids in the substrate. Examples of suitable materials include thermoplastics, epoxies, other polymeric materials, and combinations thereof. In certain aspects the polymeric comprises a thermoplastic such as, for example, a thermoplastic comprising from about 0.5 and 10 weight percent silicone and a base polymer, such as a polyethersulfone, polyetherimide, polyphenylsulfone, polyphenylene, polycarbonate, high-impact polystyrene, polysulfone, polystyrenes, acrylic, amorphous polyamide, polyester, nylon, PEEK, PEAK and ABS.

However, as noted above, due to the microscale gaps, the polymeric material may be a thermoplastic polymer having improved rigidity over silicone, nylons, ABS and the like, and may therefore exclude thermoplastic copolyesters and/or thermoplastic polyurethanes. Thus, in an aspect the polymeric material is PET (polyester), PPS (polyphenylene sulfide), PCTA (poly 1,4 cyclohexane dimethylene terephthalate), PEN (polyethylene naphthalate), PVDF (polyvinylidene fluoride), PEEK (polyetheretherketone), derivatives therefore, and combinations thereof. In one particular aspect, the polymeric material is a glycol modified polyester, such as, in an aspect, polyethylene terephthalate glycol (PETG).

Nonetheless, in one aspect, any polymeric material having a sufficient rigidity may be used. For instance, a polymer material used herein can have a Shore A Hardness as measured according to ASTM D2240 of about 60 or greater, such as about 62.5 or greater, such as about 65 or greater, such as about 67.5 or greater, such as about 70 or greater, or any values or ranges therebetween. Additionally or alternatively, the polymer material can have a Short D Hardness measured according to ASTM D2240 of about 50 or greater, such as about 52.5 or greater, such as about 55 or greater, such as about 57.5 or greater, such as about 60 or greater, or any values or ranges therebetween.

Nonetheless, as noted above, in one aspect, the substrate material and the polymeric material should be selected to have substantial similarity in polymeric structure to provide a strong bond/adhesion between the first polymeric later and the substrate. For instance, a PET substrate and a PETG first polymeric layer provide excellent bond strength due to the similarities in hydrophobicity and melt temperature, whereas a PET substrate and a urethane polymeric material do not. Thus, in one aspect, the substrate and polymeric material may be selected from any one or more of the above listing of substrates and polymeric layers, but are also selected so as to have similar melting temperatures as discussed above, as well as being selected from similar classes of polymers so as to provide excellent adhesion between the substrate and the first polymeric layer.

In some aspects, the polymeric material can also include various additives, such as carbon fibers, or other additives that improve processability or physical characteristics of the finished product. The polymeric material can also include photo-curable and self-curing resins. Photocurable resins may include resins curable by UV curing, visible light curing, electron beam curing, gamma radiation curing, radiofrequency curing, microwave curing, infrared curing, or other known curing methods involving application of radiation to cure a resin. Suitable resins may also include those that may be cured via chemical reaction without the need for added radiation as in the curing of an epoxy resin, extrusion of an autocuring polymer such as polyurethane mixture, thermal curing, solidifying of an applied hotmelt or molten thermoplastic As discussed herein, the polymeric material is dispensed onto the substrate in a flowable state. When in a flowable state, the polymeric material is also referred to herein as the “flowable material” or the “flowable polymer material” . To obtain the flowable polymer material, the polymeric material is heated to at least the melting point of the material prior to dispensing. The ability of the flowable polymer material to fill the voids in the substrate may be affected by the diameter of the voids in the substrate, and the viscosity of the flowable polymer material. In particular, it should be understood that the lower the viscosity of the flowable polymer material, the more readily the flowable polymer material will flow into voids in the substrate. In particular, lower viscosities are desirable when the void diameter or void volume is small. The flowable polymer material will thus preferably have a viscosity sufficiently low to penetrate voids in the substrate to a sufficient depth such that, upon cooling, a mechanical tension is generated. In one particular aspect, the flowable polymer material will desirably have a viscosity sufficiently low to allow the flowable polymer material to penetrate into the substrate to a depth of at least 50% of the thickness of the substrate.

The polymeric material can be heated to any temperature at which the material is flowable, including to at least the melting point of the material. In certain aspects, it may be desirable to heat the polymeric material to a temperature above its melting point. In particular, dispensing the polymeric material onto the substrate at hotter temperatures allows the material to remain in a flowable state for longer periods of time, while minimizing the viscosity, which allows for easier filling of the voids in the substrate. Dispensing the polymeric material onto the substrate at hot temperatures may also help maximize adhesion between the flowable polymer material and the filaments in the substrate as discussed above. Thus, in certain aspects, the polymeric material may be heated to at least 10° C., at least 20° C., at least 30° C., at least 40° C., at least 50° C., at least 60° C., at least 70° C., at least 80° C., at least 90° C., at least 100° C., at least 150° C., or at least 200° C. above the melting point of the material prior to dispensing as a flowable polymer material on the substrate.

It is generally preferable that the temperature of the flowable polymer material is not so high that the substrate is damaged (e.g., melted to the point of deformation, burned, or otherwise degraded) when contacted with the flowable polymer material. Thus, the polymeric material, substrate, and temperature to which the polymeric material is heated should be selected such that the polymeric material is in a flowable state when dispensed onto the substrate, but the substrate is not damaged when contacted with the flowable polymer material. Because the substrate is not damaged by the methods of the present disclosure (e.g., melted or burned), the strength of the substrate (fabric) is not compromised during the printing process. In one particular aspect, the polymeric material is heated to a temperature of at least the melting point of the polymeric material, but to no more than 10% higher, such as about 5% hither, such as about 2.5% higher, than the melting (or burning) point of the substrate.

It should be understood that it is also possible for a polymeric material heated to a temperature above the melting/burning point of the substrate to be dispensed on the substrate without damaging the substrate itself. In particular, the heating capacity of the substrate may be affected by factors other than the temperature of the flowable polymer material and the melting/burning point of the substrate. For instance, the volume of polymeric material extruded per linear distance travelled by the extrusion head (greater volume extruded increases the amount of heat applied to the substrate), filament size (thinner filaments in substrate decrease the heat capacity of the substrate), and print speed (slower printing may result in greater heat transfer from the heated extrusion head, which may melt/burn the fabric) may all affect substrate integrity and the amount of heat the substrate can absorb without damage. Thus, in other aspects, the polymeric material may be heated to temperature of at least the melting point of the polymeric material, and also above the melting (or burning) point of the substrate, so long as the substrate is not damaged by deposition of the flowable polymer material thereon and instead is merely heated to a point sufficient to meld with the polymeric material and form a good adhesion therewith.

As discussed herein, it is desirable to maximize the penetration of the flowable polymer material into the voids of the substrate. Thus, in one aspect, penetration of the flowable polymer material into the voids of the substrate may be facilitated by dispensing the flowable polymer material onto a heated substrate. By dispensing the flowable polymer material onto a heated substrate, the flowable polymer material does not cool as quickly, thus allowing a longer period of time for the flowable polymer material to penetrate and fill the voids of the substrate prior to solidifying.

Thus, in another aspect, the methods of the present disclosure may further comprise heating the substrate prior to forming the polymeric material layer(s). The substrate may be heated to any temperature at which the substrate is not damaged (e.g., melted or otherwise degraded). In one aspect, the substrate is heated to a temperature of at least 70° C., or at least 80° C., at least 90° C., at least 100° C., at least 110° C., at least 120° C., at least 130° C., at least 140° C., at least 150° C., at least 180° C., at least 200° C., at least 220° C., at least 250° C., or at least 270° C. In one aspect, the substrate is heated to a temperature below the melting point of the substrate, including 1° C., 2° C., 5° C., 10° C., 15° C., 20° C., 30° C., 40° C., 50° C., 60° C., 70° C., 80° C., 90° C., or 100° C. below the melting point of the substrate. The substrate may be heated using any suitable means known in the art for heating of fabric substrates. In one aspect, the substrate is placed on a supporting plate or belt during formation of the 3D elements, and is heated by heating the plate or belt to the desired temperature. In one aspect, the flowable polymer material is not subjected to a cooling step following dispensing on the substrate, but instead is allowed to solidify at ambient temperatures. Thus in another aspect, the extrusion head does not contact the top surface of the substrate when forming the polymeric.

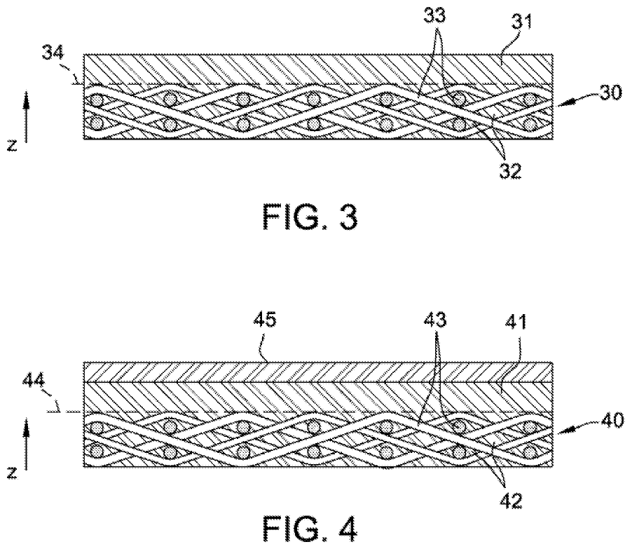

For instance, with reference to FIG. 3, depicted therein is a cross-sectional view of an exemplary substrate 30 with a polymeric material 31 disposed thereon. Polymeric material 31 fills the voids 32 in substrate 30, surrounding the filaments 33 of the substrate. Polymeric material 31 extends in a z direction above the top 34 of the substrate.

Nonetheless, the present disclosure is also generally directed to a method of additively manufacturing a fabric. For instance, in one aspect, a substrate formed from a plurality of filaments and voids between the filaments, and having a top (i.e., extrusion head facing) surface, a bottom surface opposite to the top surface, an x-y plane, and a thickness extending from the bottom surface to the top surface in a z-direction perpendicular to the x-y plane, can be contacted with a first polymeric material by dispensing onto the top surface of the substrate a flowable polymer material from an extrusion head transported in the x and/or y directions over the top surface of the substrate. Further, as discussed above, at least a portion of the voids are filled with the flowable polymer material. In addition, after formation of the first polymeric material, at least one additional polymeric material layer is formed on the substrate by incrementally transporting the extrusion head in the z direction away from the top surface of the substrate, wherein at least a portion of the at least one additional layer contacts the first polymeric layer. Moreover, the process is repeated until the pattern height discussed above is achieved.

In one aspect, it can be beneficial to determine a spatial relationship between the substrate (fabric) and the extruder head. More particularly, identifying a top of the substrate (i.e., the highest point to which filaments in the substrate extend in the z direction). The top of the substrate can be identified by i) transporting the extrusion head over the top surface of the substrate in the x-y plane without contacting the substrate; and ii) while transporting the extrusion head over the top surface of the substrate, incrementally lowering the extrusion head in the z direction towards the top surface of the substrate until the filaments of the substrate begin to degrade (e.g., melt or otherwise show damage or degradation). In one aspect, the extrusion head is transported over the top surface of the substrate without dispensing polymeric material. The point at which filaments of the substrate begin to degrade (e.g., melt, burn, or otherwise show damage or degradation) may be determined using any suitable means, including visually or microscopically. The extrusion head may be lowered towards the top surface of the substrate in any suitable increment. In one aspect, the extrusion head may be lowered towards the top surface of the substrate in increments of 60 um, 50 μm, 40 um, 30 um, 20 μm, 10 μm, 5 μm, 3 μm, 2 μm, or 1 μm until damage to the filaments is observed.

Once the top of the substrate is determined, the extrusion head may be set at a height above the top of the substrate prior to forming the first polymeric material layer. As discussed herein, this ensures the polymeric material extends above the top surface of the substrate. The height of the extrusion head above the top of the substrate may vary. In certain aspects, the height of the extrusion head is at least 0.01 mm, at least 0.05 mm, at least 0.07 mm, at least 0.1 mm, at least 0.15 mm, at least 0.17 mm, at least 0.2 mm, at least 0.25 mm, at least 0.27 mm, or at least 0.3 mm above the top of the substrate. In one particular aspect, the height of the extrusion head is set to 0.2 mm above the top of the substrate.

Once the extruder head height has been selected, the maximum volumetric flow rate for the extruder at the selected height can be calculated. Maximum volumetric flow rate may be determined by the following process:
1) Set up the printer/extruder with the desired substrate and extrusion head set to the desired height.
2) Print a series of about 50 mm lines with a constant volume of extruded material per linear distance traveled (cm³/cm), while increasing the travel speeds starting at a slow speed and incrementally increasing the speed (e.g., 600, 700, 800, 900, 1000, 1100, 1200, 1300, 1400, up to 1500 mm/min or higher).
3) Visually determine the highest speed that generates consistent extrusion.
4) Calculate maximum volumetric flow rate by multiplying the travel speed of the extrusion head by the volume of extruded material per linear distance traveled.

In one aspect, the maximum volumetric flow rate for the extruder may be from about 0.01 to about 0.02 cm³/second.

Once the maximum volumetric flow rate is determined, the extrusion volume (e.g., volume of polymeric material) dispensed onto the substrate per distance travelled by the extrusion head (“volume per linear distance”) can be determined. The extrusion volume per linear distance travelled by the extruder head needed to achieve adequate adhesion of the polymeric material may be determined using the following procedure:
1) Print a series of patterns that exhibit 2 dimensional characteristics (e.g., circles, squares, or some other non-linear shape) onto the substrate. This allows adherence of the polymeric material to be tested in different directions of printing. Print each set of patterns with a different cm³/cm value at the appropriate speed needed to maintain the calculated maximum volumetric flow rate at the selected extruder head height.
2) Subject the patterns to a platform adhesion test. This test may include, for example, bending the fabric at a severe radius, and mechanically attempting to pry the polymeric from the substrate.

An extrusion volume (e.g., volume of polymeric material) per distance travelled by the extrusion head (cm³/cm) that balances the desired print speed and quality may then be chosen. Appropriate extrusion volume per distance travelled by the extrusion head may vary widely, depending on the extruder used and ultimate design of the 3D elements to be printed. In one aspect, the volume per distance may be from about 0.02 to about 0.2 cm³/cm.

The maximum linear speed at which the printer/extruder operates may be determined from the maximum volumetric flow rate at the selected height and the volume per linear distance. In certain aspects, the polymeric material layer(s) is formed by transporting the extrusion head at a linear speed of from about 4 to about 40 mm/sec.

As discussed above, the polymeric material is formed in a pattern over the entire surface area of the substrate (i.e., a continuous pattern) with the limitations set forth above. For example, the polymeric material is applied at discrete locations according to the pattern selected. In such aspects, because the polymeric material is only present at certain locations on the substrate, some of the voids in the substrate remain open (i.e., at locations where the polymeric material is not present), which allows for increased air permeability through the finished forming wire. In such aspects, the polymeric material forming the pattern (containing the 3D elements) is adhered to the substrate at discrete locations, while still allowing for air permeability through the fabric.

For instance, FIG. 4, depicts a cross-sectional view of an exemplary substrate 40 with a polymeric material 41 thereon. Polymeric material 41 fills the voids 42 in substrate 40 corresponding to the desired surface pattern (shown more clearly in FIG. 5), surrounding the filaments 43 of the substrate. Polymeric material 41 extends in a z direction above the top 44 of the substrate. On first polymeric material layer 41 is an additional polymeric layer 45, which is coextensive with polymeric material layer 41. Additional polymeric material layer 45 may be a single layer or may be multiple layers of FDM printed layers which form pattern on the forming wire, and, in one aspect, additional polymeric material layer 45 is formed from the same, or generally the same, polymer as polymeric material layer 41.

Nonetheless, as illustrated in FIG. 4, the pattern formed by first polymeric material layer 41 and additional polymeric material layer 45 has a height in the Z direction extending from the substrate.

Referring next to FIGS. 5A and 5B, a portion of a forming wire 100 according to the present disclosure is shown with a completed pattern 102 formed from one or more polymeric materials on substrate 104. As shown in FIG. 5A, which illustrates the forming wire 100 in the flat orientation, gaps 106 (shown in FIG. 5B) are virtually invisible to the human eye, and instead allow a continuous pattern to be utilized for forming fibrous materials. Conversely, the same sample is shown in FIG. 5B, which illustrates the forming wire 100 in a flexed orientation. As illustrated, the gaps 106 are now visible, as they allow the pattern to flex around a roll diameter without damage to the pattern 102. Further, as illustrated, the polymeric material utilized to form the pattern 102 is not disposed on the substrate in the gap 106 region of the substrate 104. Furthermore, as illustrated most clearly in FIG. 5B, discrete sections 110 are spaced apart in the machine direction (MD), where the pattern 102 is continuous within the respective section 110, and having a gap-to-gap distance (gd) and a gap width (gw) (more clearly shown in the flexed orientation.

Based upon the desired pattern height, additional layer(s) as described herein may be utilized, and can be a single layer, or more typically, multiple layers of FDM printed layers which form the pattern on the fabric. The additional layer(s) are formed on the substrate by transporting the extrusion head in the x and/or y direction over the top surface of the substrate to form the desired pattern, while dispensing an additional flowable material. Elevation is provided to the 3D elements by incrementally transporting the extrusion head in the z direction away from the top surface of the substrate. The material used to form the additional layer(s) may be the same or different than the polymeric material. In one aspect, the additional layer(s) and polymeric material are formed from the same material. In one aspect, the additional layer(s) and polymeric are formed from the same material and the extrusion head used to form the polymeric is also used to form the additional layer(s). In certain aspects the pattern is formed by extruding, such as that disclosed in U.S. Pat. No. 5,939,008, the contents of which are incorporated herein by reference in a manner consistent with the present disclosure, or printing, such as that disclosed in U.S. Pat. No. 5,204,055, the contents of which are incorporated herein by reference in a manner consistent with the present disclosure, a polymeric material onto the substrate. In other aspects the 3D element(s) may be produced, at least in some regions, by extruding or printing two or more polymeric materials.

In one aspect the pattern or pattern element(s) are formed using SFF or layer manufacturing (LM) techniques, such as 3D printing techniques described in U.S. Pat. No. 5,204,055. Generally, 3D printing techniques may be employed to form an element from a series of layers of material with each layer printed and formed on top of the previous layer.

Three-dimensional printing of the elements generally begins with creating a computer model of the element in three dimensions using a suitable computer modeling program known in the art. The computer model of the element is completely sectioned into a series of horizontal digital slices to define a set of slice patterns for each layer.

In one aspect the pattern is formed using one or more printheads that span at least a portion of the width of the substrate. The printheads (also referred to herein as extrusion heads) may be moveable so as to print materials onto a static substrate, or the substrate may be moved and the printheads may be fixed. Regardless, it is generally preferred that the moving object be moved at a substantially constant speed in a flat plane. In one particularly preferred aspect a plurality of printheads extend across the width of the belt, which is moved in a flat plane during printing, perpendicular to the direction of travel of the substrate and are, preferably, spaced along the substrate with substantially constant separations. However, constant separation of the printheads is not critical.

The printheads print one layer of an element onto the previously printed layer. Thus the first printhead prints the first layer, the second printhead prints a second layer onto the first layer and the Nth printhead prints an Nth layer onto the (n-1)th layer. The printhead used to print the additional layers may be the same or different than what is used to dispense the polymeric material. In one aspect, the printhead used to print the additional layer(s) is the same as the printhead used to dispense the polymeric material.

The layers are of a constant thickness and the printheads are controlled so that, in plan view, layers are printed on top of each other. The distance from each of the printheads to the surface upon which they print is also preferably the same for all printheads. Thus the distance from the first printhead to the substrate is preferably the same as the distance from the seventh printhead to the sixth layer. This may be achieved by sequentially raising the printhead(s) for each layer by the voxel height. In this situation, droplets ejected by printheads for different layers at exactly the same time will arrive at their destinations at the same time.

The materials printed by the printheads (and used to form the additional layer(s)) may include photo-curable and self-curing resins. Photocurable resins may include resins curable by UV curing, visible light curing, electron beam curing, gamma radiation curing, radiofrequency curing, microwave curing, infrared curing, or other known curing methods involving application of radiation to cure a resin. Suitable resins may also include those that may be cured via chemical reaction without the need for added radiation as in the curing of an epoxy resin, extrusion of an autocuring polymer such as polyurethane mixture, thermal curing, solidifying of an applied hotmelt or molten thermoplastic.

In one aspect, the polymeric material layer(s) are formed by an LM method comprising an extrusion head that extrudes heated, flowable modeling material from a nozzle onto the substrate. The extruded material is deposited layer-by-layer in areas defined from a CAD model, as the extrusion head and the substrate are moved relative to each other in three dimensions by an x-y-z gantry system. The material solidifies after it is deposited to form a three-dimensional element. The material may be a thermoplastic material which solidifies after deposition by cooling. The polymeric material is deposited in areas defined from a CAD model along the lines discussed herein. Namely, the CAD model or Solidworks model contains a pattern discussed above separated into separate and distinct segments in the machine direction by utilizing gaps as discussed above. As will be shown more clearly in FIG. 5 below, the gaps are inserted into the pattern after formation of the pattern, so that the pattern is continuous (e.g. continues from the same pattern without restarting at a non-matching portion of the pattern) on either side of the gap, such that, when in the flat orientation, the gap, or any change in pattern, is not visible to the human eye.

Extrusion heads and systems suitable for preparing three-dimensional elements as described above are commercially available from Stratasys@ modeling machines. The extrusion head, which includes a liquefier and a dispensing nozzle, receives modeling material in a solid form. The filament is heated to a flowable temperature inside the liquefier and it is then dispensed through the nozzle. Thermoplastic materials have been found particularly suitable for deposition modeling in the Stratasys® modeling machines. A controller controls movement of the extrusion head in a horizontal x, y plane, controls movement of the build platform in a vertical z-direction, and controls the feeding of modeling material into the head. By controlling these processing variables, the modeling material is deposited at a desired flow rate in “beads” or “roads” layer-by-layer in areas defined from the CAD model to create a three-dimensional object that resembles the CAD model. The modeling material thermally solidifies, and the finished model is removed from the substrate.

Furthermore, the forming wire of the present disclosure is well suited for forming nonwoven webs and articles therefrom. As noted above, products such as wipes, absorbent articles, personal care articles, and the like can benefit from forming wires discussed herein with increased pattern height.

As an example only, in one aspect, a nonwoven web can be a carded web, particularly a bonded carded web. Once the web is formed, the web is then bonded using one or more bonding methods. In one aspect, for instance, the carded web can be bonded using through-air bonding. Through-air bonding, for instance, controls the level of compression or collapse of the nonwoven web during the bonding process. In through-air bonding, heated air is forced through the web to melt at least one component within the web to cause bonding sites to form. During through-air bonding, the nonwoven web can be supported on the forming wire as discussed herein to form bond points as well as surface pattern. In addition, optionally a vacuum may be pulled through the web in order to better control the process.

The present disclosure may be better understood with reference to the following example.

### EXAMPLE

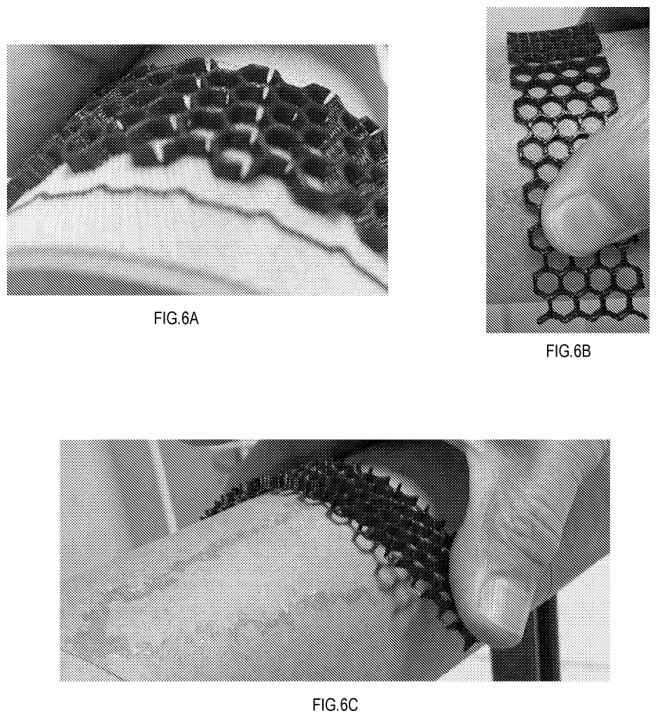

A sample according to the present disclosure was formed as illustrated in FIG. 6A. Namely, the sample forming wire illustrated in FIG. 6A was formed on a polyethylene terephthalate substrate utilizing a glycol modified polyethylene terephthalate (PETG) polymeric material for all of the layers forming the pattern. The sample contained gaps having a gap width of 0.12 mm in the flat orientation, a gap-to-gap distance of 1 cm, and a pattern height of 4 mm. As shown in FIG. 6A, the sample formed according to the present disclosure is capable of flexing around a 7.5 mm diameter roll without distortion of the pattern or cupping between the forming wire and the roll.

Two comparative samples, illustrated in FIGS. 6B and 6C, were formed in the same manner as the sample, except that no gaps were formed. In addition, FIG. 6B illustrates a comparative sample having a pattern height of 2 mm, whereas FIG. 6C has a pattern height of 4 mm. As shown in FIG. 6B, even with only an element height of 2 mm, the forming wire of FIG. 6B exhibits cupping around a 7.5 mm roll. Further, as illustrated in FIG. 6C, the comparative sample having an element height of 4 mm is incapable of flexing around a 7.5 mm diameter roll without breaking.

These and other modifications and variations to the present disclosure may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

1. A forming wire comprising:
a substrate having a top surface, a bottom surface opposite to the top surface, an x-y plane, and a thickness extending from the bottom surface to the top surface in a z-direction perpendicular to the x-y plane, the substrate comprising a plurality of filaments and voids between the filaments;
a plurality of discrete sections comprising at least a first section and a second section, each section comprising a continuous pattern disposed on the substrate, wherein the continuous pattern has a pattern height of greater than 0.8mm; and
a microscale gap disposed between each discrete section of the plurality of discrete sections.

2. The forming wire of claim 1, wherein each discrete section has a section length of about 2 cm or less.

3. The forming wire of claim 1, wherein the continuous pattern has a pattern height of greater than about 2 mm.

4. The forming wire of claim 1, wherein at least about 10% of the top surface of the substrate within a respective discrete section has the continuous pattern disposed thereon.

5. The forming wire of claim 1, , wherein at least about 30% of adjacent pattern elements within a respective section share at least one connection point.

6. The forming wire of claim 1, where the microscale gap disposed between each discrete patterned section has a gap width in a flat orientation of 500 micrometers or less.

7. The forming wire of claim 1, wherein the continuous pattern comprises circles, ovals, triangles, crosses, squares, rectangles, diamond shapes, hexagons, other polygons, lines, swirls, stars, characters, emblems, or combinations thereof.

8. The forming wire of claim 1, wherein the continuous pattern in each discrete section comprises the same shape or combination of shapes.

9. The forming wire of claim 1, wherein the continuous pattern in adjacent discrete sections comprises a different shape or combination of shapes.

10. The forming wire of claim 1, wherein the continuous pattern is formed from a polymeric material, optionally wherein the polymeric material is a thermoplastic, an epoxy, or combination thereof.

11. The forming wire of claim 1, wherein the plurality of filaments are formed from a thermoplastic resin, a silicone rubber, or a non-silicone vulcanized rubber.

12. The forming wire of claim 1, wherein the continuous pattern includes a first polymeric layer directly adjacent to the top surface of the substrate, wherein the first polymeric layer encircles and/or is fused to one or more substrate filaments.

13. The forming wire of claim 1, wherein a melting point of the polymeric material differs from a melting point of the substrate by about 20% or less.

14. The forming wire of claim 1, wherein the substrate is polyethylene terephthalate.

15. The forming wire of claim 1, wherein the polymeric material is a glycol modified polyethylene terephthalate.

16. The forming wire of claim 1, wherein each microscale gap comprises a gap region extending between adjacent discrete sections, wherein at least one gap region is generally free of the polymeric material.

17. The forming wire of claim 16, wherein each respective gap region overlies a portion of the substrate, wherein the portion of the substrate within the gap region is generally free of the polymeric material.

18. The forming wire of claim 1, wherein the polymeric material is disposed on the substrate via additive manufacturing, preferably wherein the polymeric material is disposed on the substrate via a fused deposition modeling (FDM) process.

19. A method of manufacturing a forming wire according to claim 1, the method comprising:
forming the continuous pattern on the substrate by dispensing onto the top surface of the substrate a first polymeric material layer from an extrusion head transported in the x and/or y plane over the top surface of the substrate, wherein at least a portion of the voids are filled with the polymeric material; and
dispensing one or more additional layers of the polymeric material onto the first polymeric material layer until the pattern height is reached.

20. A method of forming a nonwoven web comprising:
forming a plurality of fibers;
disposing the plurality of fibers on the forming wire of any one of claims 1 to 19; and
drying the plurality of fibers.
